(19) United States
(12) Patent Application Publication
(10) Pub. No.: US 2012/0108098 A1
(43) Pub. Date: May 3, 2012

(54) PUSH-ON CABLE CONNECTOR WITH A COUPLER AND RETENTION AND RELEASE MECHANISM

(76) Inventors: Donald Andrew Burris, Peoria, AZ (US); William Bernard Lutz, Glendale, AZ (US)

(21) Appl. No.: 13/281,983

(22) Filed: Oct. 26, 2011

Related U.S. Application Data
(60) Provisional application No. 61/407,232, filed on Oct. 27, 2010.

(51) Int. Cl. H01R 13/62

(52) U.S. Cl. 439/345

(57) ABSTRACT

A cable connector comprising a coupler and a retainer having a base with an internal channel and a latching assembly is disclosed. The coupler has a first end, a second end, and a bore extending therethrough. The latching assembly comprises a beam having a first end and a second end. The latching assembly pivotably connects to the base and has a plurality of teeth extending radially inwardly through a latch slot towards the bore of the coupler. A spring clip radially inwardly biases the coupler. The coupler has at least one compression slot that responds to the radially inwardly bias of the coupler, compressing the coupler radially inwardly and, thereby, providing a resiliently friction fit function to the coupler.

### RELATED APPLICATIONS

This application claims the benefit of priority under 35 U.S.C. §119 of U.S. Provisional Application Ser. No. 61/407,232 filed on Oct. 27, 2010 the content of which is relied upon and incorporated herein by reference in its entirety.

### BACKGROUND OF THE INVENTION

1. Field of the Invention

The field of the disclosure relates to electrical cable connectors. More particularly, the disclosure relates to a push-on coaxial cable connector with a compression type coupler and a retention and release mechanism that automatically and securely latches the connector to an equipment port when pushed-on the equipment port and remains latched until intentionally released by manipulating the mechanism.

2. Technical Background

Coaxial cable connectors, such as type F connectors, are used to attach coaxial cable to another object or appliance, e.g., a television set, DVD player, modem or other electronic communication device having a terminal adapted to engage the connector. The terminal of the appliance includes an inner conductor and a surrounding outer conductor.

Coaxial cable includes a center conductor for transmitting a signal. The center conductor is surrounded by a dielectric material, and the dielectric material is surrounded by an outer conductor; this outer conductor may be in the form of a conductive foil and/or braided sheath. The outer conductor is typically maintained at ground potential to shield the signal transmitted by the center conductor from stray noise, and to maintain a continuous desired impedance over the signal path. The outer conductor is usually surrounded by a plastic cable jacket that electrically insulates, and mechanically protects, the outer conductor. Prior to installing a coaxial connector onto an end of the coaxial cable, the end of the coaxial cable is typically prepared by stripping off the end portion of the jacket to expose the end portion of the outer conductor. Similarly, it is common to strip off a portion of the dielectric to expose the end portion of the center conductor.

Coaxial cable connectors of the type known in the trade as “F connectors” often include a tubular post designed to slide over the dielectric material, and under the outer conductor of the coaxial cable, at the prepared end of the coaxial cable. If the outer conductor of the cable includes a braided sheath, then the exposed braided sheath is usually folded back over the cable jacket. The cable jacket and folded-back outer conductor extend generally around the outside of the tubular post and are typically received in an outer body of the connector; this outer body of the connector is usually fixedly secured to the tubular post. A coupler is typically rotatably secured around the tubular post and includes an internally-threaded region for engaging external threads formed on the outer conductor of the appliance terminal.

When connecting the end of a coaxial cable to a terminal of a television set, equipment box, or other appliance, it is important to achieve a reliable electrical connection between the outer conductor of the coaxial cable and the outer conductor of the appliance terminal. Typically, this goal is achieved by ensuring the coupler of the connector is fully tightened over the connection port of the appliance. When fully tightened, the head of the tubular post of the connector directly engages the edge of the outer conductor of the appliance port, thereby making a direct electrical ground connection between the outer conductor of the appliance port and the tubular post; in turn, the tubular post is engaged with the outer conductor of the coaxial cable.

With the increased use of self-install kits provided to home owners by some CATV system operators has come a rise in customer complaints due to poor picture quality and/or poor data performance in computer/internet systems. Additionally, CATV system operators have found upstream data problems induced by entrance of unwanted RF signals into their systems. Complaints of this nature result in CATV system operators having to send a technician to address the issue. Often times it is reported by the technician that the cause of the problem is due to a loose F connector fitting, sometimes as a result of inadequate installation of the self-install kit by the home owner. An improperly installed or loose connector may result in poor signal transfer because there are discontinuities along the electrical path between the devices, resulting in ingress of undesired radio frequency (“RF”) signals where RF energy from an external source or sources may enter the connector/cable arrangement causing a signal to noise ratio problem resulting in an unacceptable picture or data performance. Many of the current state of the art F connectors rely on intimate contact between the F male connector interface and the F female connector interface. If, for some reason, the connector interfaces are allowed to pull apart from each other, such as in the case of a loose F male coupler, an interface “gap” may result. If not otherwise protected this gap can be a point of RF ingress as previously described.

As mentioned above, the coupler is rotatably secured about the head of the tubular post. The head of the tubular post usually includes an enlarged shoulder, and the coupler typically includes an inwardly-directed flange for extending over and around the shoulder of the tubular post. In order not to interfere with free rotation of the coupler, manufacturers of such F-style connectors routinely make the outer diameter of the shoulder (at the head of the tubular post) of smaller dimension than the inner diameter of the central bore of the coupler. Likewise, manufacturers routinely make the inner diameter of the inwardly-directed flange of the coupler of larger dimension than the outer diameter of the non-shoulder portion of the tubular post, again to avoid interference with rotation of the coupler relative to the tubular post. In a loose connection system, wherein the coupler of the coaxial connector is not drawn tightly to the appliance port connector, an alternate ground path may fortuitously result from contact between the coupler and the tubular post, particularly if the coupler is not centered over, and axially aligned with, the tubular post. However, this alternate ground path is not stable, and can be disrupted as a result of vibrations, movement of the appliance, movement of the cable, or the like.

Alternatively, there are some cases in which such an alternate ground path is provided by fortuitous contact between the coupler and the outer body of the coaxial connector, provided that the outer body is formed from conductive material. This alternate ground path is similarly unstable, and may be interrupted by relative movement between the appliance and the cable, or by vibrations. Moreover, this alternate ground path does not exist at all if the outer body of the coaxial connector is constructed of non-conductive material. Such unstable ground paths can give rise to intermittent failures that are costly and time-consuming to diagnose.

One method used to ensure reliable electrical and mechanical communication between the coupler and the post of the coaxial connector has been to utilize an o-ring as a means to force the coupler proximate the post by means of axially compressing the o-ring. While this method works well to address the electrical concerns noted above it can result in situations where the coupler is more difficult to rotate as compared to other type F connectors in the marketplace.

Alternatively, Male Type F connectors are available with spring fingers which form an interference fit when pushed over the outer threaded portion of a female Type F receptacle. Type F connectors comprising spring fingers may be of dubious reliability because interface retention at the junction relies upon the interference fit between the spring fingers and the threaded outer portion of the port. The amount of retention is typically a compromise between ease of insertion and retention. Typically this type of solution is found in an adaptor that does not attach directly to a coaxial cable, but, rather, adapts a cable connector interface to a push-on interface simply moving the problem of a loose coupler down the line. The push on interface itself does, however, address one basic problem; that of a loose threaded coupler at the immediate junction. By eliminating the threaded coupler issues of improper installation, intermittent connection and RF ingress are at least partially addressed albeit the challenge of connector retention remains.

Additionally, there appears to be no means in the art offered to directly attach a self-retaining yet easily disengaged push-on interface directly to a coaxial cable in the field.

### SUMMARY OF THE DETAILED DESCRIPTION

Embodiments disclosed in the detailed description include a push-on cable connector having a retention mechanism. According to one embodiment a cable connector having a coupler and a retainer is provided. The coupler has a first end and a second end. The first end is adapted to receive an end of a cable. A retainer attaches to the coupler. The retainer has a pivotable latching assembly. When a force is applied to the latching assembly, the latching assembly pivots in a direction moving from a first position. When the force is removed from the latching assembly, the latching assembly pivots in an opposite direction moving toward the first position. The first position may be a latched position or an un-latched position. The coupler is radially inward biased allowing the coupler to provide a resilient friction fit function. The coupler is adapted to receive a component, for example, such as an equipment port of an appliance. In this manner, when the equipment port is received by the coupler, the coupler compresses around the equipment port so that the equipment port is resiliently friction fitted to the connector. The latching assembly is adapted to automatically engage the equipment port, when it is received by the connector. The latch assembly is adapted to releasably retain the equipment port to the retainer. The latch assembly may be adapted to engage a thread of the equipment port.

According to another embodiment a cable connector having a coupler with a first end, a second end, and a bore extending therethrough, and a retainer is provided. The second end is radially inwardly biased. The retainer has a base with an internal channel and a latching assembly pivotably connected to the shaft. The first end of the body positions within the channel of the base. The latching assembly has a plurality of teeth extending radially inwardly towards the bore of the coupler proximate the coupler. The latching assembly is configured to automatically latch the retainer to a component, such as, for example, an equipment port of an appliance using at least one of the plurality of teeth. The latching assembly is configured to unlatch the retainer from the component by applying a force to the latching assembly.

The latch assembly comprises a beam having a first end and a second end. The plurality of teeth extends from the second end of the beam. The latch assembly pivotably connects to the base at a location on the beam between the first end and the second end of the beam. The first end of the beam has a grip portion adapted for receiving force applied to the beam to pivot the beam and, thereby, unlatch the retainer. The coupler also has a tubular post attached. The tubular post extends from the first end through the channel and is adapted to receive an end of a cable. A spring clip attaches at least partially around the coupler and may be one of the ways for providing the radially inwardly bias to the coupler. The coupler is adapted to receive the equipment port such that the equipment port is resiliently friction fitted to the connector. The latch assembly is adapted to engage a thread of the equipment port with at least one of a plurality of teeth engages a thread of the equipment port.

In another embodiment, a cable connector comprising a coupler and a retainer having a base with an internal channel and a latching assembly is provided. The coupler has a first end, a second end, and a bore extending therethrough. The second end is radially inwardly biased. The first end of the coupler positions within the channel of the base. The latching assembly comprises a beam having a first end and a second end. The latch assembly pivotably connects to the base at a location on the beam between the first end and the second end of the beam. The latching assembly has a plurality of teeth extending radially inwardly from the second end of the beam towards the bore of the coupler proximate to the coupler. The beam may be a plurality of beams. The coupler has an annular groove. A spring clip positions in the annular groove at least partially around the coupler and provides the radially inwardly bias to the coupler. The coupler has at least one latch slot, wherein the at least one of the plurality of teeth extends radially inwardly through the at least one latch slot into the bore. The coupler has at least one compression slot, wherein the at least one compression slot responds to the radially inwardly bias of the coupler, compressing the coupler radially inwardly and, thereby, providing a resiliently friction fit function to the coupler. The base has one or more strain relief slots formed therein. The at least one of the plurality of teeth may extend past the second end of the body.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 is a perspective cross sectional view of an exemplary embodiment of a push-on cable connector with a coupler and a retention and release mechanism;

FIG. 2 is an exploded perspective view of the connector of FIG. 1 with the coupler and the retainer shown in a separated orientation;

FIG. 3 is a front schematic view of the connector of FIG. 1;

FIG. 4 is a top schematic view of the connector of FIG. 1;

FIG. 5 is a cross-sectional view of the connector of FIG. 1 with a cable installed therein;

FIGS. 6A, 6B and 6C are partial cross-sectional views of the connector with strain relief and with a cable installed therein and in different states of connection to an equipment port;

FIG. 7 is a cross-sectional view of an exemplary embodiment of a connector;

FIG. 8 is a front schematic view of the connector of FIG. 7;

FIG. 9 is a cross-sectional view of an exemplary embodiment of a connector with a latching assembly having teeth that extend past the connector and a coupler with a spring clip;

FIG. 10 is a cross-sectional view of an exemplary embodiment of a connector with latching assembly having teeth that extend past the connector and a coupler without a spring clip;

FIG. 11 is a cross-sectional view of an exemplary embodiment of post-less connector with a coupler and a retainer; and

FIGS. 12A-12E are cross-sectional views of exemplary embodiments of connectors with couplers and retainers.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

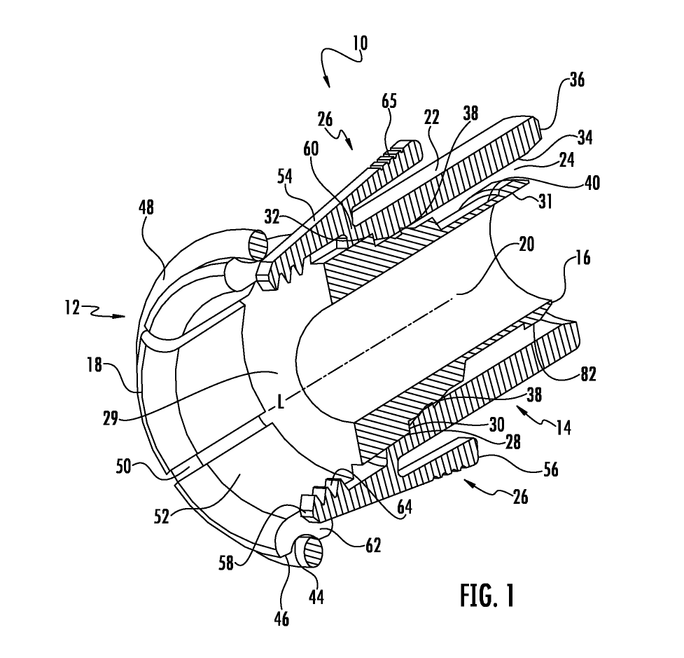

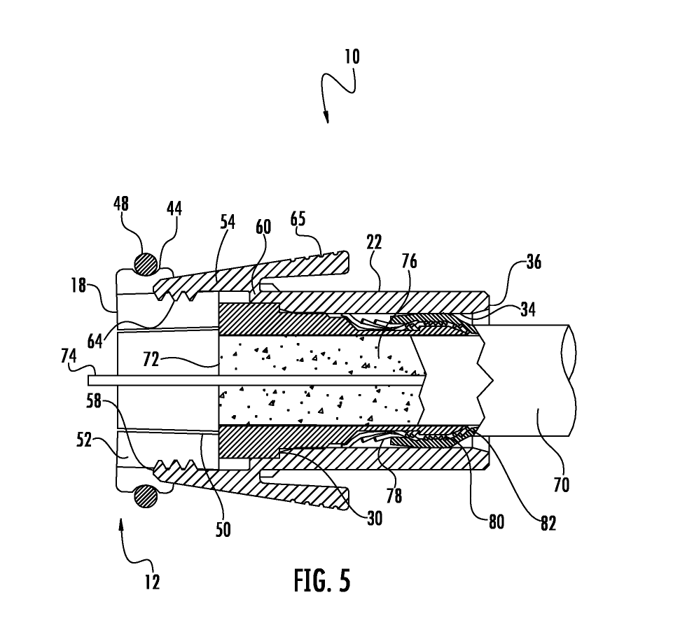

FIG. 1 is a perspective cross sectional view of an exemplary embodiment of a push-on cable connector with a coupler and a retention and release mechanism. The cable connector is intended to be used to connect a cable, for example, without limitation, a coaxial cable, to a component, for example, without limitation, an equipment port of an appliance. In this regard, the connector 10 has a coupler 12 and a retainer 14. The coupler 12 has a first end 16 and a second end 18. The first end 16 is adapted to receive an end of the cable, while the second end 18 is adapted to receive the component, including the equipment port. A bore 20 extends through the coupler 12 from the first end 16 through the second end 18. The bore 20 may be used for the passage of portions of the cable, to secure the cable (not shown in FIG. 1) to the connector 10, provide for the passage of the conductor of the cable, and establish the electrical connectivity, mechanical connection, grounding continuity and RF protection of the cable with the connector and, thereby, with the equipment port. The attachment of a cable to the connector is discussed in more detail with reference to FIG. 5, below. The coupler 12 may be made from metallic material such as brass and plated with a conductive corrosion resistant material, such as tin. The retainer 14 may be made from a resilient polymer material such as acetyl.

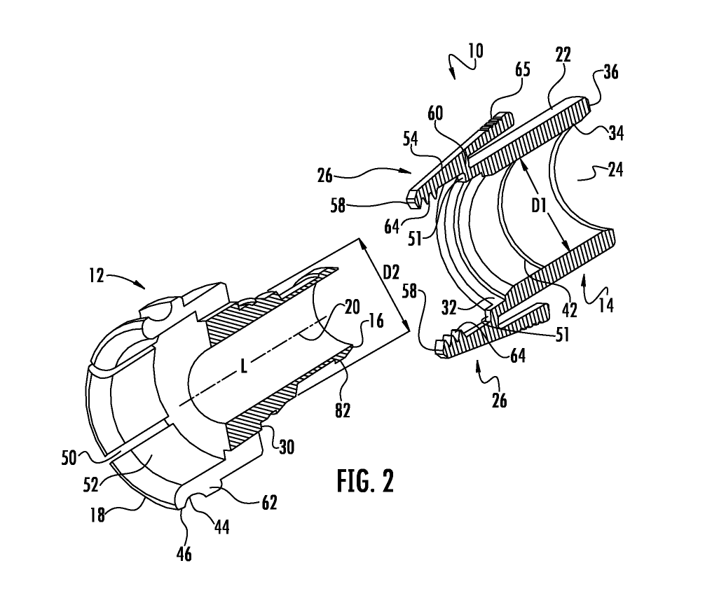

FIG. 2 illustrates an exploded perspective view of the connector 10 with the coupler 12 and the retainer 14 shown in a separated orientation. Reference will be made to FIG. 2 in addition to FIG. 1 to describe the assembly of the coupler 12 and the retainer 14. In this embodiment, the retainer 14 has a base 22 with a first end 36, a second end 51, and an internal channel 24 and a latching assembly 26. The channel 24 of the base 22 has a diameter “D1” that is larger than the outer diameter “D2” of the first end 16 of the coupler 12. This allows the first end 16 of the coupler 12 to mount within the channel 24. In this regard, once the cable is attached to the coupler 12, as will be described below with reference to FIG. 5, the coupler 12 and the retainer 14 may be assembled by inserting the first end 16 of the coupler 12 into the channel 24 from the end of the base 22 that would be proximal to the component to which the cable is being connected, for example the equipment port of an appliance. An annular shoulder 28 having a forward facing surface 29 and a rearward facing surface 30 is formed in the first end 16 of the coupler 12. A tubular post 31 extends from the annular shoulder 28. The first end 16 inserts into the channel 24 until the rearward facing surface 30 of the annular shoulder 28 contacts a forward facing annular surface 32 extending radially inwardly from the inside surface 34 of the channel 24. In this manner, the coupler 12 and the retainer 14 are releasably lock together. An annular barb 38 protrudes from the outside surface 40 of the tubular post 31. The annular barb 38 acts to dig into the material of the retainer 14 when the coupler 12 and the retainer 14 are assembled providing additional means to secure the coupler 12 and the retainer 14 together. Additionally or alternatively, the retainer 14 may have a notch 42 cut into the inside surface 34 of the channel 24. The annular barb 38 may insert into the notch 42 when the coupler 12 and the retainer 14 are assembled.

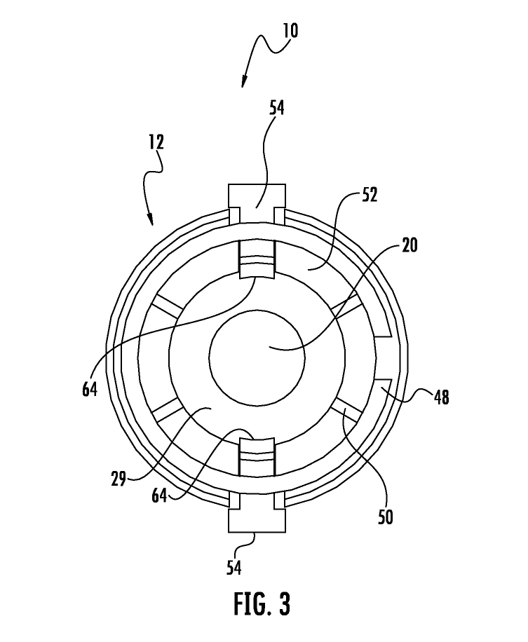

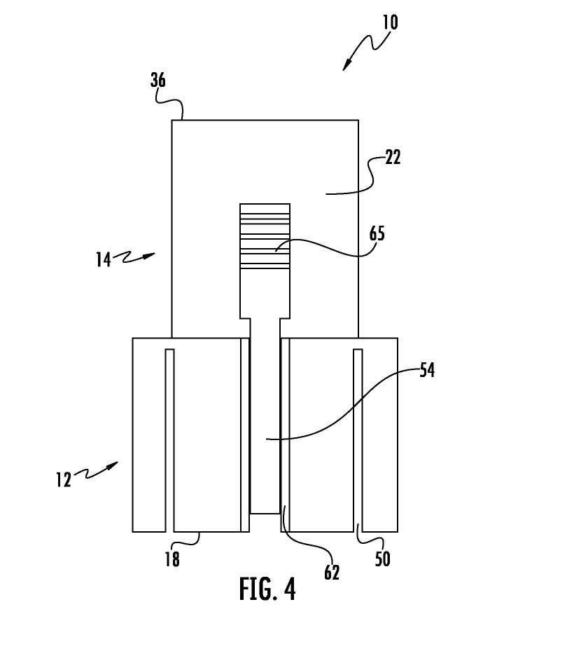

FIG. 3 and FIG. 4 illustrate front schematic and top schematic views, respectively, of connector 10. Reference will be made to FIGS. 3 and 4, in addition to FIG. 1 to further describe the coupler 12. The second end 18 of the coupler 12 is adapted to receive a component, such as, for example, an equipment port of an appliance to which the cable is being connected by the connector 10. The second end 18 is radially inwardly biased allowing the second end 18 to radially compress around a component received by, or inserted into, the coupler 12. In this way, the coupler 12 provides a resilient friction fit function to the component. Referring again to FIG. 1, the second end 18 of the coupler 12 has an annular groove 44 cut circumferentially into the outer surface 46 of the coupler 12. A spring clip 48 fits into the annular groove 44 such that the spring clip 48 extends at least partially around the outer surface 46 of the coupler 12 and provides a radially, inwardly bias to the second end 18 of the coupler 12. Additionally, the coupler 12 may have least one compression slot 50 resulting in one or more coupler sections 52. The coupler sections 62 respond to the radially inwardly bias of the coupler 12, moving or forced toward the longitudinal axis “L” of the bore 20, allowing the second end 18 of the coupler 12 to compress radially inwardly. In this manner, the coupler 12 provides a friction fit function to a component, such as, for example, an equipment port of an appliance, received by the second end 18 of the coupler 12. In other words, by the connector 10 being pushed onto the equipment port, the equipment port is resiliently friction fit to the coupler 22, and, thereby, to the connector 10, without the need for rotating any portion of the connector 10. Further, since the equipment port and the connector 10 are resiliently friction fit to each other, the connector 10 can be released or removed from the equipment port by just pulling the connector 10 from the equipment port, without having to rotate any portion of the connector 10.

Continuing with reference to FIGS. 1, 3 and 4, the latching assembly 26 comprises a beam 54 having a first end 56, a second end 58, and a flexible portion 60 therebetween. The latching assembly 26 pivotably connects to the base 22 at the flexible portion 60 of the beam 54. The connection of the beam 54 to the base 22 at the flexible portion 60, allows the beam 54 to pivot when a force is applied to one of the first end 56 and second end 58. As can be seen best with reference to FIG. 1, an initial orientation of beam 54 is angled downwardly with respect to the second end 58 such that the second end 58 is closer to the bore 20 than the first end 56. The coupler 12 has at least one latch slot 62. Teeth 64 extend radially inwardly from the second end 58 of the beam 54 toward the bore 20, or a point internal to the bore 20 through the latch slot 62. While in FIGS. 1 and 3 the latching assembly 26 is shown as having two beams 54, any number of beams 54, including one, may be included or used. Additionally, there may be one latch slot 62 for each beam 54.

The latching assembly 26 may be biased to a first position. In this embodiment, the first position is the initial orientation with the second end 58 of the beam 54 angled downwardly, although the latching assembly 26 may be biased in other initial orientations. However, when a force is applied to the latching assembly 26, the latching assembly 26 pivots in a direction moving from the first position. When the force is removed from the latching assembly 26, the latching assembly pivots in an opposite direction moving back toward the first position. The first position may be a latched position or an un-latched position. In this manner, the latching assembly 26 is adapted to automatically engage an equipment port inserted into the second end 18 of the coupler 12, and to releasably retain the retainer 14, and thereby, the connector 10 to the equipment port.

FIG. 5 is a cross-sectional view of the connector 10 with a cable 70 installed therein. The first end 16 of the coupler 12 is adapted to receive an end 72 of the cable 70. In FIG. 5, the cable 70 is shown as a coaxial cable. The cable 70 has center conductor 74. The center conductor 74 is surrounded by a dielectric material 76, and the dielectric material 76 is surrounded by an outer conductor 78 that may be in the form of a conductive foil and/or braided sheath. The outer conductor 78 is usually surrounded by a plastic cable jacket 80 that electrically insulates, and mechanically protects, the outer conductor 78. A prepared end of the coaxial cable 70 is inserted through the first end 34 of the channel 24 and onto the tubular post 31. A compression tool (not shown) may be used to feed the cable 70 into the coupler 12 of the connector 10 such that a raised area 82 extending from the tubular post 31 of the coupler 12 inserts between the dielectric material 76 and the outer conductor 78 of the cable 70, making contact with the outer conductor 78. The center conductor 74 extends through the bore 20 of the coupler 12 to and through the second end 18. The compression tool may also be used to advance the retainer 14 over the first end 16 of the coupler 12. As the retainer 14 advances over the first end 16 of the coupler 12, the inside surface 34 of the channel 24 squeezes against the cable jacket 78. In this manner, the cable 70 is retained in the connector 10. Additionally, the raised area 82 positioned between the dielectric material 76 and the outer conductor 78 acts to maximize the retention strength of the cable jacket 80 within the connector 10. As the retainer 14 moves toward the second end 18 of the connector 10, the retainer 14 causes the cable jacket 80 to be pinched between the inside surface 34 of the channel 24 and the raised area 82 increasing the pull-out force required to dislodge cable 70 from the connector 10. Since the outer conductor 78 is in contact with the first end 16 of the coupler 12 an electrically conductive path is established from the outer conductor 78 through the coupler 12 and, thereby, to the equipment port (not shown in FIG. 5).

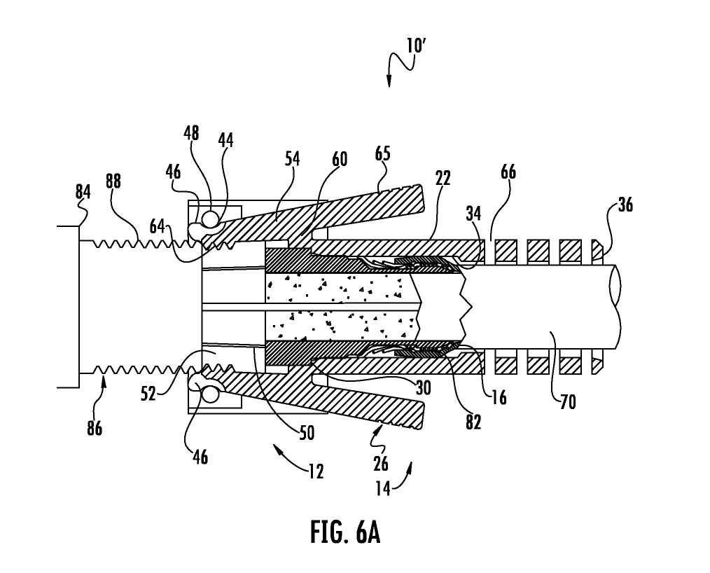

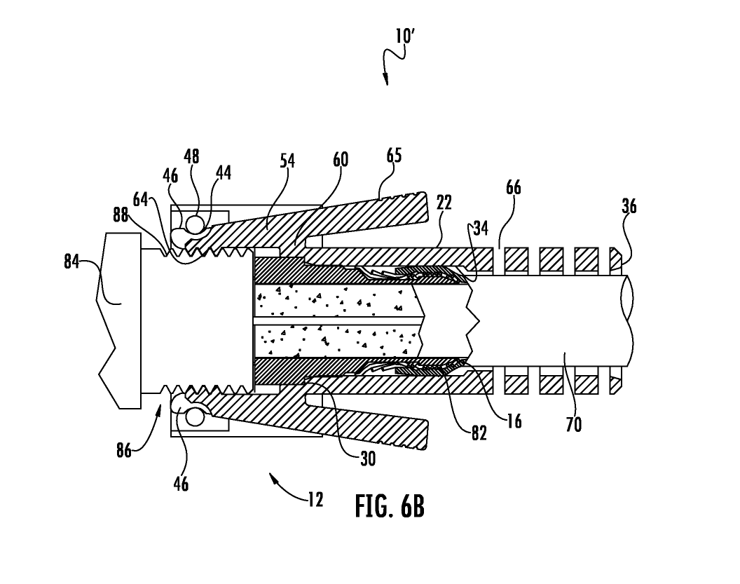

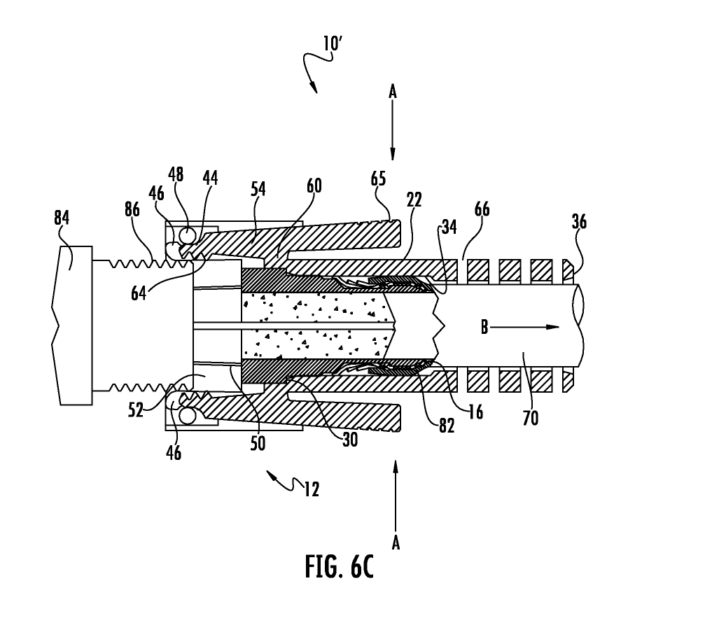

FIGS. 6A, 6B and 6C are partial cross-sectional views of the connector 10′ with a cable 70 installed therein and in relation to an equipment port 84. Additionally, the base 22 of the retainer 14 has a first end 56 formed as a series of strain relief slots 66 to provide strain relief for the cable 70. FIG. 6A illustrates the connector 10′ as partially connected to the equipment port 84. The center conductor 74 of the cable 70 engages with the equipment port 84 as the second end 18 of the coupler 12 receives threaded portion 86 of the equipment port 84. At this point, there is electrical and mechanical communication between the connector 10′ and the equipment port 84. Additionally, the compression slots 50 allow the coupler sections 52 to flex radially outwardly as the coupler 12 receives the equipment port 84. Even though the coupler sections 52 flex radially outwardly, the coupler 12 continues to exert a radially inward bias as urged on by the spring clip 48. Also, the inherent resiliency of the material of the coupler 12 promotes the radially inward bias.

FIG. 6B illustrates the connector 10′ in a position advanced axially toward the equipment port 84. As the connector 10′ advances, the second end 18 of the coupler 12 receives the equipment port 84 such that the threaded portion 86 is friction fitted within the bore 20 due to the radially inward bias of the coupler 12. Additionally, as the threaded portion 86 contacts the teeth 64 extending from the second end 58 of the beam 54, the threaded portion 86 forces the teeth 64 to move causing the beam 54 to pivot about the flexible portion 60 from a first position. In this manner, the teeth 64 are allowed to advance over the threaded portion 86 until the equipment port 84 stops advancing, for example, when the equipment port 84 contacts the forward facing surface 29 of the annular shoulder 28. At that point, the beam 54 pivots back toward the first position allowing the teeth 64 to engage one or more of the threads 88 of the threaded portion 86, latching the retainer 14, and, thereby, the connector 10, to the equipment port 84. Thus, in addition to the friction fit of the coupler 12 on to the threaded portion 86 of the equipment port 84, the latching assembly 26 latches the connector 10′ to the equipment port 84 causing an increasing resistance to disengagement of the connector 10′ from the equipment port 84. The connector 10′ may remain latched to the connector port 84 until intentionally unlatched. Moreover, in this manner, the coupler 12 and the retainer 14 provide that at any point of engagement between connector 10′ and equipment port 84 a reliable ground path and RF shield is established, ensuring proper electrical function.

FIG. 6C illustrates the connector 10′ partially uninstalled from the equipment port 84. A grip portion 65 is located on the first end 56 of the beam 54. An unlatching force “A” may be applied to the grip portion 65 of the first end 56 of the beam 54. Unlatching force “A” may pivot the beam 54 thereby disengaging the teeth 64 from the threads 88 of the equipment port 84. Once the teeth 64 are disengaged from the threads 88, a pull-out force “B” applied to the retainer 14 will overcome the compression providing the friction fit of the coupler 12 to the equipment port 84, thereby, axially moving away or withdrawing the connector 10′ from the equipment port 84. In this manner, the connector 10′ may be released and/or detached from the equipment port 84.

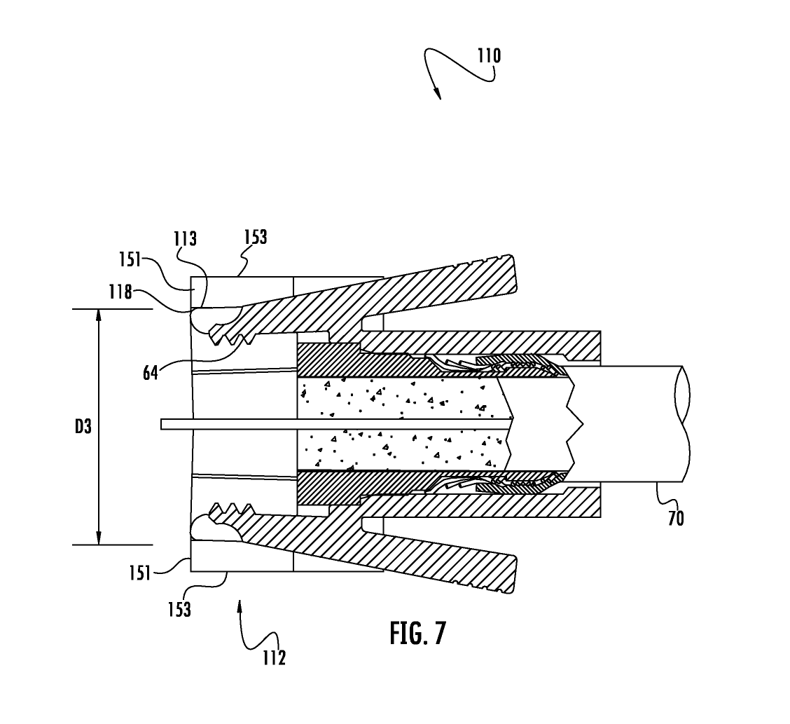

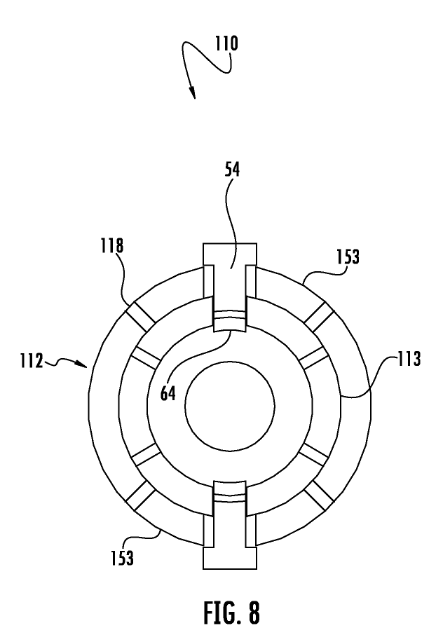

FIG. 7 is a cross-sectional view of another exemplary embodiment of a connector 110. FIG. 8 is a front schematic view of connector 110. Connector 110 is similar to connector 10 except that connector 110 does not have a spring clip 40. Instead, the second end 151 of the base 122 of the retainer 114 has outer fingers 153 that extend over the second end 118 of the coupling 112. The outer fingers 153 have an inner diameter “D3” sized such that the inside surface 113 of the outer fingers 153 provides a radially inwardly bias on the coupling 112 resulting in the friction fit function for retaining the equipment port 84 in the coupler 112. In other words, because of the size of the inner diameter “D3”, the natural resiliency of the material of the coupler 112 is sufficient to provide an effective radially inwardly biasing such that a spring clip 48 is not needed. The latching assembly 26 functions in the same manner as described above for connector 10.

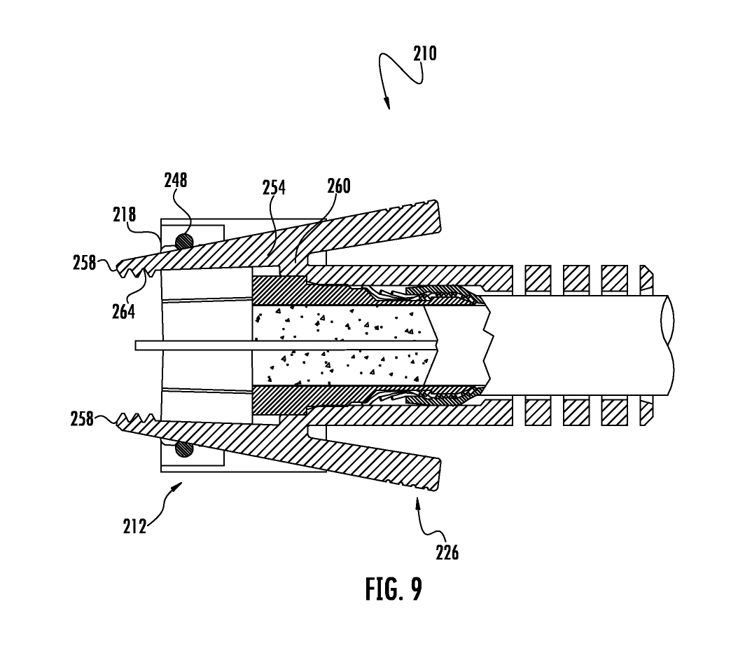

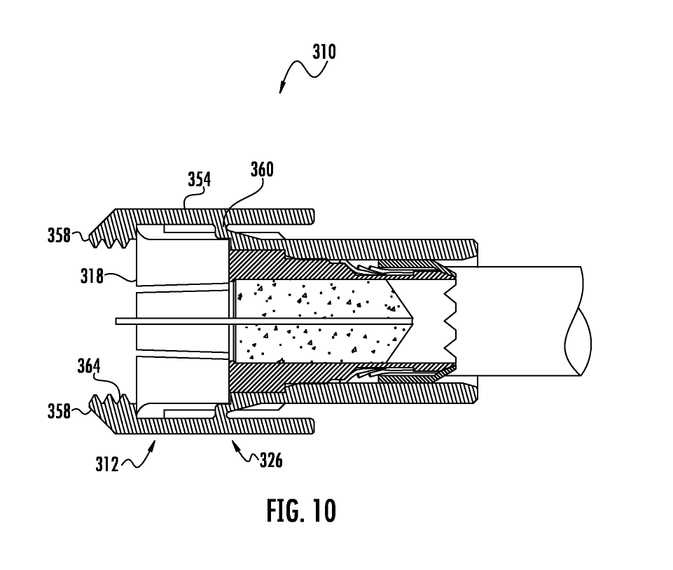

FIG. 9 and FIG. 10 are cross-sectional views of exemplary embodiments of connectors 210, 310 with latching assemblies 226, 326 having teeth 264, 364 that extend past the second end 218, 318 of the connector 210, 310. FIG. 9 illustrates a connector 210 with a spring clip 248, while FIG. 10 illustrates a connector 310 without a spring clip. The latching assemblies 226, 326 have beams 254, 354 with a flexible portions 260, 360 that allow the beams 254, 354 to pivot in the same manner as described with respect to connector 10. However, the beams 254, 354 have second ends 258, 358 that extend farther from the flexible portions 260, 360 resulting in the teeth 264, 364 being out from the coupler 212, 312. Therefore, the teeth 264, 364 will contact the equipment port 84 before the couplers 212, 312. In this way, connectors 210, 310 can also accommodate equipment ports 84 having longer threaded portions 86.

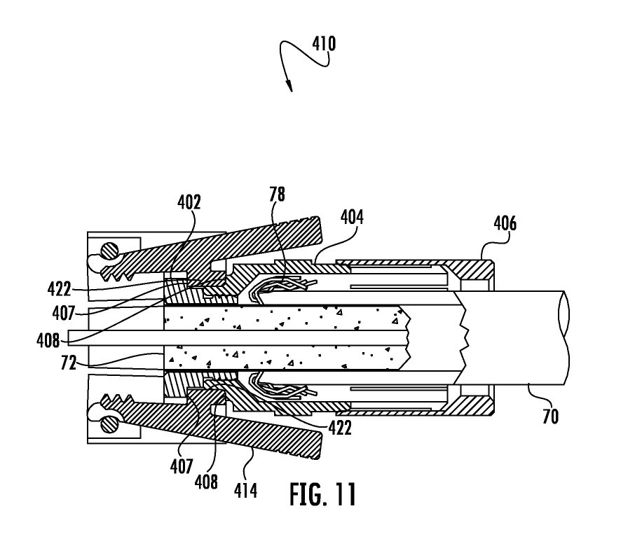

FIG. 11 is a cross-sectional view of a post-less connector 410. The first end 416 of the coupler 412 is not a tubular post, but is a collar 402. Therefore, instead of a tubular post inserting between the dielectric material 76 and the outer conductor 78 of a cable 70 inserted into the connector 410, the prepared end 72 of the cable 70 extends through a body 404 to the collar 402. A shell 406 slides over the body 404 and compresses the body against the outer conductor 78 and the cable jacket 80. In this manner, the cable 70 is retained in the connector 410. The base 422 of the retainer 414 positions between opposite faces 407, 408 of the collar 402 and the body 404, respectively. As the shell 406 is slid over the body 404, the body 404 moves toward the collar 402 thereby squeezing the base 422 between the opposite faces 407, 408. In this manner, the retainer 414 is releasably attached to the coupler 412, and, thereby, the connector 410. The coupler 412 receives the equipment port 84 or other component and the retainer latches and unlatches the equipment port 84 in the same manner as described above.

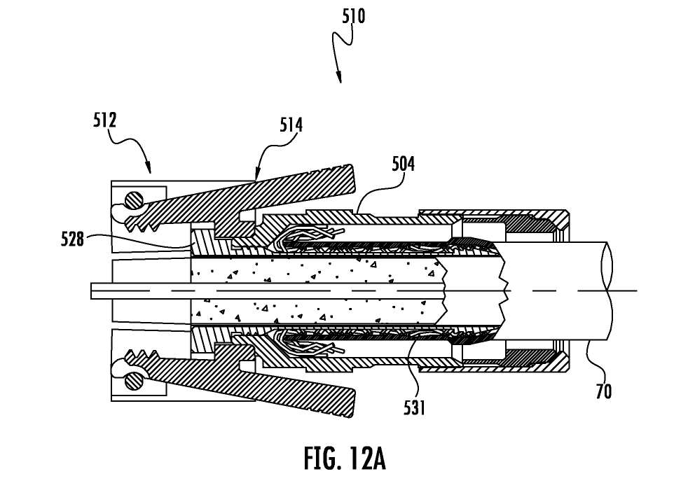

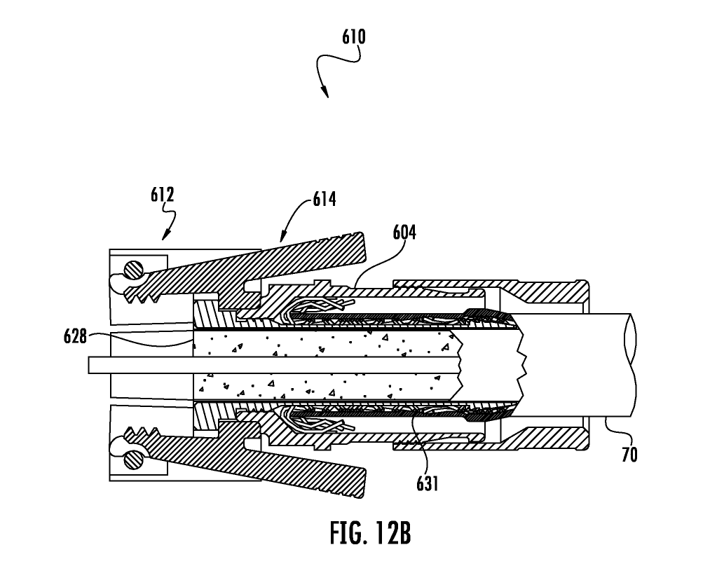

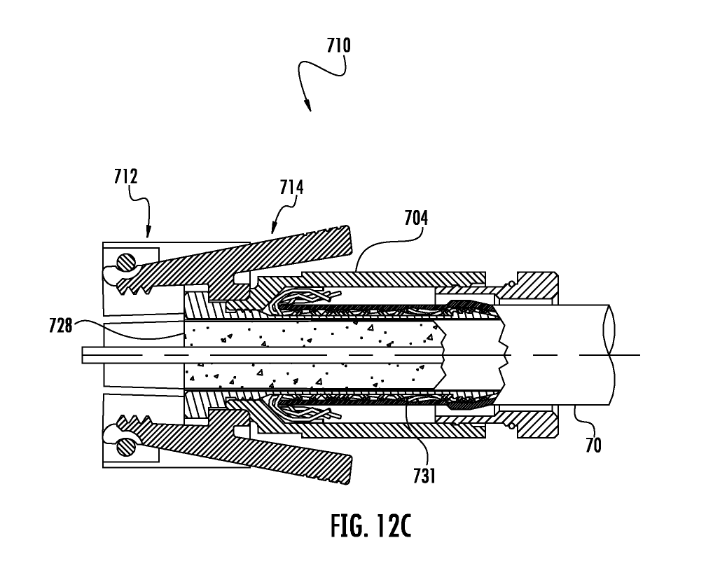

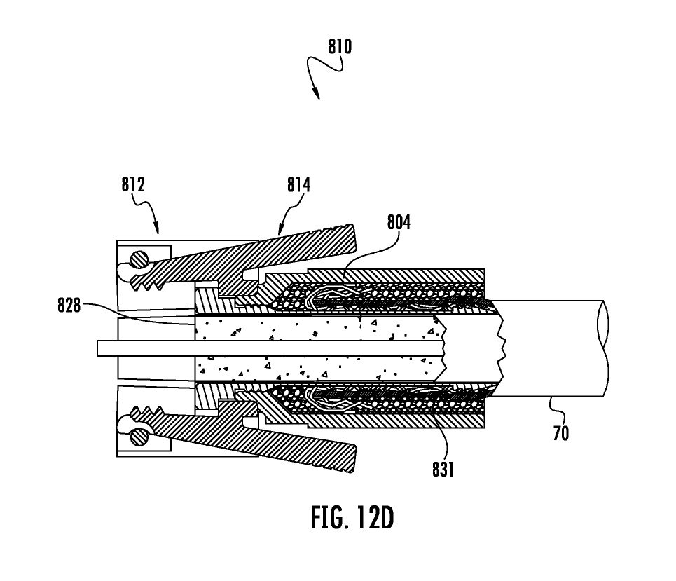

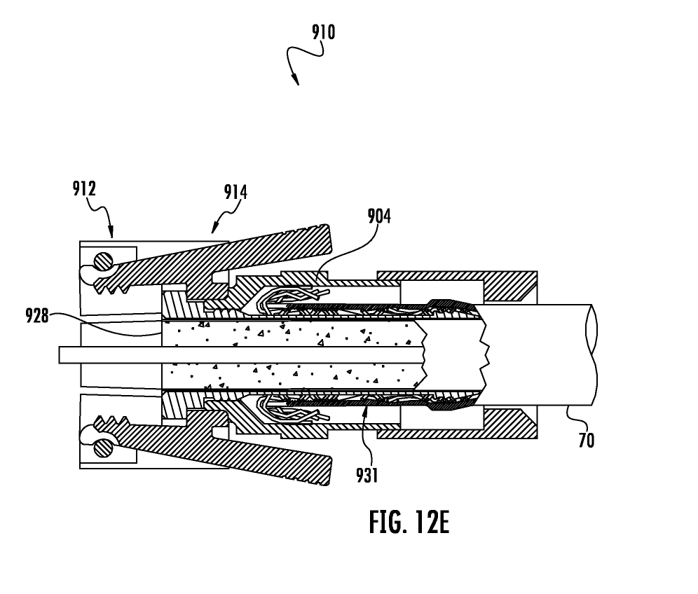

FIGS. 12A-12E illustrate other embodiments of connectors 510, 610, 710, 810 and 910 which include couplers 512, 612, 712, 812 and 912 and retainers 514, 614, 714, 814 and 914. The couplers 512, 612, 712, 812 and 912 have tubular posts 531, 631, 731, 831 and 931 that extend from annular shoulder 528, 628, 728, 828 and 928. The connectors 510, 610, 710, 810 and 910 have bodies 504, 604, 704, 804 and 904. The retainers 514, 614, 714, 814 and 914 attach to the connectors 510, 610, 710, 810 and 910 by the bases being captured between opposing faces of the annular shoulders 528, 628, 728, 828 and 928 and the bodies 504, 604, 704, 804 and 904 in a similar manner as described above with respect to FIG. 11. Additionally, the couplers 512, 612, 712, 812 and 912 and retainers 514, 614, 714, 814 and 914 engage and latch to an equipment port in the same manner as described above with respect to other embodiments.

Many modifications and other embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims.

It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. A cable connector, comprising:
a coupler, wherein the coupler is radially inwardly biased;
a retainer attached to the coupler, the retainer having a pivotable latching assembly, wherein when a force is applied to the latching assembly, the latching assembly pivots in a direction moving from a first position, and when the force is removed from the latching assembly, the latching assembly pivots in an opposite direction moving toward the first position.

2. The cable connector of claim 1, wherein the first position is a latched position.

3. The cable connector of claim 1, wherein the first position is an unlatched position.

4. The cable connector of claim 1, wherein the radially inward bias of the coupler allows the coupler to provide a resilient friction fit function.

5. The cable connector of claim 1, wherein the coupler is adapted to receive an equipment port such that the coupler is resiliently friction fitted to the equipment port.

6. The cable connector of claim 1, wherein the latching assembly is adapted to automatically engage an equipment port received by the cable connector.

7. The cable connector of claim 6, wherein the latch assembly is adapted to releasably retain the equipment port to the retainer.

8. The cable connector of claim 7, wherein the latch assembly is adapted to engage a thread of the equipment port.

9. The cable connector of claim 1, wherein the coupler has a first end and a second end.

10. The cable connector of claim 9, and wherein the first end is adapted to receive an end of a cable.

11. A cable connector, comprising:
a coupler having a first end, a second end, and a bore extending therethrough, wherein the second end is radially inwardly biased;
a retainer having a base with an internal channel, and a latching assembly pivotably connected to the base, wherein the first end of the coupler positions within the channel of the base, and wherein the latching assembly has a plurality of teeth extending radially inwardly towards the bore of the coupler proximate to the second end.

12. The cable connector of claim 11, wherein the latching assembly is configured to automatically latch the retainer using at least one of the plurality of teeth.

13. The cable connector of claim 11, wherein the latching assembly is configured to unlatch the retainer by applying a force to the latching assembly.

14. The cable connector of claim 11, wherein the latch assembly comprises a beam having a first end and a second end, and wherein the plurality of teeth extends from the second end of the beam, and wherein the latch assembly pivotably connects to the base at a location on the beam between the first end and the second end.

15. The cable connector of claim 14, wherein the first end of the beam has a grip portion adapted for receiving force applied to the beam for pivoting the beam and unlatching the retainer.

16. The cable connector of claim 11, wherein the first end of the coupler comprises a tubular post, wherein the tubular post extends in the channel and, wherein the tubular post is adapted to receive an end of a cable.

17. The cable connector of claim 11, further comprising a spring clip, wherein the spring slip attaches at least partially around the coupler and provides the radially inwardly bias to the coupler.

18. The cable connector of claim 11, wherein the first end of the coupler is adapted to receive an equipment port such that the equipment port is resiliently friction fitted to the cable connector.

19. The cable assembly of claim 11, wherein the latch assembly is adapted to engage a thread of the equipment port.

20. The cable assembly of claim 19, wherein the at least one of a plurality of teeth engages a thread of the equipment port.

21. A cable connector, comprising:
a coupler having a first end, a second end, and a bore extending therethrough, wherein the coupler is radially inwardly biased;
a retainer having a base with an internal channel and a latching assembly, wherein the latching assembly comprises a beam having a first end and a second end, and wherein a plurality of teeth extends from the second end of the beam, and wherein the latch assembly pivotably connects to the base at a location on the beam between the first end and the second end of the beam, and wherein the first end of the body positions within the channel of the shaft, and wherein the latching assembly has a plurality of teeth extending radially inwardly from the second end of the beam towards the bore of the body proximate to the second end.

22. The cable connector of claim 21, wherein the beam comprises a plurality of beams.

23. The cable connector of claim 21, wherein the coupler has an annular groove, and wherein a spring clip positions in the annular groove at least partially around the coupler and provides the radially inwardly bias to the coupler.

24. The cable connector of claim 21, wherein the coupler has at least one latch slot, and wherein the at least one of the plurality of teeth extends radially inwardly through the at least one latch slot into the bore.

25. The cable connector of claim 21, wherein the coupler has at least one compression slot, wherein the at least one compression slot responds to the radially inwardly bias of the coupler providing a resiliently friction fit function to the coupler.

26. The cable connector of claim 21, wherein the base has one or more strain relief slots formed therein.

27. The cable connector of claim 21, wherein at least one of the plurality of teeth extends past the second end of the body.
